(19) United States
(12) Patent Application Publication
(10) Pub. No.: US 2025/0265492 A1
(43) Pub. Date: Aug. 21, 2025

(54) METHOD FOR PREDICTING SEAWATER INTRUSION INDEX WITH MULTIPLE PARAMETERS IN GROUNDWATER FOR SUSTAINABLE GROUNDWATER MANAGEMENT

(71) Applicant: KING FAHD UNIVERSITY OF PETROLEUM AND MINERALS, Dhahran (SA)

(72) Inventors: Galal Munassar Bin MAKHASHEN, Dhahran (SA); Mohammed Hasan BENAAFI, Dhahran (SA)

(73) Assignee: KING FAHD UNIVERSITY OF PETROLEUM AND MINERALS, Dhahran (SA)

(21) Appl. No.: 18/583,240

(22) Filed: Feb. 21, 2024

(51) Int. Cl. G06N 20/00; G06N 5/022

(52) U.S. Cl. CPC G06N 20/00; G06N 5/022

(57) ABSTRACT

A computer-implemented method for predicting a Seawater intrusion index in coastal aquifers in arid regions with multiple parameters in groundwater for a sustainable groundwater management includes selecting multiple parameters based on the level of informative contribution and the multicollinearity to obtain an input dataset, partitioning the input dataset into a modeling dataset and a testing dataset, dividing the modeling dataset into a training set and a validation set and tuning hyperparameters based on a grid search strategy for each model, training each model based on the training set and hyperparameters, evaluating each model based on the validation set and multiple statistical performance metrics, selecting a prediction model based on the testing dataset and the multiple statistical performance, predicting the Seawater intrusion index from the prediction model, and creating an adaptive groundwater management strategy based on the SWI index.

### STATEMENT OF ACKNOWLEDGEMENT

This research was supported by the Deanship of Research Oversight and Coordination (DROC) at King Fahd University of Petroleum & Minerals (KFUPM) under the Interdisciplinary Research Center for Membranes and Water Security [Grant Number: INMW2308]. The authors acknowledge the support provided by King Fahd University of Petroleum and Minerals (KFUPM).

### BACKGROUND

### Technical Field

The present disclosure is directed to a method, system and apparatus used to analyze seawater intrusion, focusing on natural calamity monitoring, early warning systems, and environmental protection, and more particularly relates to a method for predicting a Seawater intrusion (SWI) index in coastal aquifers in arid regions with a plurality of parameters in groundwater for sustainable groundwater management.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Seawater intrusion (SWI), as the name suggests, refers to a natural phenomenon that occurs when seawater intrudes coastal aquifers. The coastal aquifers, also known as freshwater aquifers, are underground layers of permeable rock, sediment, or soil that are situated near coastlines. These aquifers contain freshwater and are often in direct hydraulic connection with the adjacent seawater. The freshwater in coastal aquifers typically comes from sources such as rainfall, rivers, or inland recharge, while the seawater intrusion occurs when seawater infiltrates these aquifers. The interface between freshwater and seawater in coastal aquifers is dynamic and subject to changes due to various factors, including tidal fluctuations, groundwater extraction, and geological conditions.

Coastline and island regions present significant opportunities for socioeconomic growth that result an escalating need for freshwater resources from aquifers, higher demand increases the risk of overexploitation. At such places, the seawater intrusion poses a significant threat to the sustainability of groundwater resources in coastal areas. Seawater intrusion is a common challenge in coastal areas. The intermixing of the two leads to groundwater quality degradation. Balancing the extraction of freshwater from these aquifers with the prevention of saltwater through seawater intrusion is crucial for sustaining a reliable source of drinking water and preventing contamination of the groundwater. In some cases, it has been found that the Seawater intrusion may also be caused by human activities.

Seawater intrusion may be triggered by various factors, including excessive water extraction, limited recharge rate, geological structure, climate change, and sea-level fluctuations. There is a plurality of methods implied in the known art to mitigate the effects of seawater intrusion. However, the effectiveness of these methods depends on various parameters, such as precipitation patterns, lithological properties, geological structures, aquifer properties, and financial limitations. Apart from the aforementioned methods, the seawater intrusion requires regular groundwater monitoring and utilize predictive modeling techniques for quantifying and predicting seawater intrusion rate, as recommended strategies for restricting its impacts and effectively regulating groundwater quality in coastal aquifers.

Traditionally, one or more methods are utilized for Searwater intrusion assessment and monitoring. For example, a groundwater flow modeling, and groundwater head measurements based method is disclosed in the art. The landward gradient of the groundwater head can be used as an indicator of seawater intrusion encroachment. However, due to salinity and density variations, interpreting the hydraulic head is difficult. Moreover, although groundwater flow and transport models are comprehensive approaches for the searwater intrusion assessment and monitoring, their calibration processes can be difficult and time-consuming, and the resulting data may not be sufficient.

Geophysics-based techniques have also been used in order to obtain a three-dimensional groundwater salinity mapping. However, a sophisticated calibration process is again necessary to effectively distinguish the signals originating from lithological features, geological structures, and water salinity.

An improved process, namely hydrochemical and environmental tracers-based technique is known for salinity mapping. Monitoring seawater intrusion using the aforementioned technique involves the utilization of major ions and stable isotopes as essential environmental tracers to evaluate the extent of seawater intrusion. Tracers are frequently subjected to multivariate analysis and are a cost-effective and readily obtainable means of characterizing groundwater systems, owing to their widespread use in exploration and relatively low testing costs. Monitoring tracers, such as chloride levels in aquifers, is a widely used approach for detecting the extent of seawater intrusion in coastal groundwater which is also to quantify the groundwater mixing ratio in the groundwater system and are considered as a main seawater intrusion index. This index is a standard metric for assessing the degree of groundwater contamination by comparing chloride concentrations in water samples to the chloride content of freshwater and groundwater. However, the hydrochemical and environmental tracers-based method may not accurately capture the complex geographical and temporal patterns of seawater intrusion, as it often relies on relatively small samples.

Machine learning (ML) has recently received attention for its applications in groundwater and water quality. The ML models are used in the identification of a plurality of other parameters, such as predicting and modeling the water quality index, phosphorus contamination in surface water, groundwater level prediction, groundwater salinity modeling, and groundwater salinity simulations. Currently, Machine learning algorithms are becoming an intensive research topic to address groundwater issues in coastal regions. For example, a conventional technique is used to evaluate three artificial intelligence-based algorithms to map the groundwater salinity in the southern coastal part of the Caspian Sea using hydrogeological and climatological data (See: Hossein Sahour, Vahid Gholami, Mehdi Vazifedan, “A comparative analysis of statistical and machine learning techniques for mapping the spatial distribution of groundwater salinity in a coastal aquifer”, ScienceDirect, Journal of hydrology, Volume 591, December 2020, 125321). It was found that the extreme gradient boosting method was the most effective, with the aquifer transmissivity being a crucial parameter for salinity prediction. However, the main focus of this study was to highlight the potential of ML for salinity mapping to delineate SWI fronts. Also, the study was not focused on quantifying the groundwater mixing ratio.

Another research work proposed four ML models to predict the chloride content and sodium adsorption ratio in a coastal aquifer affected by seawater intrusion in Chaouia, Morocco. (See: Ali El Bilali, Abdeslam Taleb, Ayoub Nafii, Bahija Alabjah, Nouhaila Mazigh, “Prediction of sodium adsorption ratio and chloride concentration in a coastal aquifer under seawater intrusion using machine learning models”, ScienceDirect, Environmental Technology & Innovation, Volume 23, August 2012, 101641). The results identified that the artificial neural network (ANN) and stochastic gradient descent models performed the best and were the most accurate and stable. However, the study was also not focused on quantifying the groundwater mixing ratio.

Another research work incorporated three AI-based algorithms for example, ANN, support vector machine and adaptive neuro-fuzzy inference system into the supervised committee machine artificial intelligence model to improve the seawater intrusion vulnerability assessment of the groundwater in the Rood Aquifer, Iran. (See: Mojgan Bordbar, Aminreza Neshat, Saman Javadi, Biswajeet Pradhan, Barnali Dixon, Sina Paryani, “Improving the coastal aquifers' vulnerability assessment using SCMAI ensemble of three machine learning approaches”, Springer Link, Volume 110, pages 1799-1820, (2022)). It was identified that an upgraded SCMAI model exhibited superior performance in the spatial prediction of sensitive zones of seawater intrusion compared with other models. However, the prime focus of this study was on defining vulnerable zones rather than quantifying the groundwater mixing ratio.

Each of the references mentioned above has one or more drawbacks that hinder their widespread adoption. As mentioned above, the SWI index is a standard metric for assessing the degree of seawater contamination by comparing the chloride concentrations in water samples to the chloride content of freshwater and seawater, considering its strong association with the SWI index. However, these methods have limitations. For instance, they may not accurately capture the complex geographical and temporal patterns of the SWI, as they often rely on relatively small samples. Despite extensive research in this field, none of the studies have proposed a comprehensive and straightforward approach to quantify the seawater intrusion index (SWI Index) without the inclusion of chloride data in the water sample under examination. Consequently, there is a dire need for a system or a method capable of efficiently quantifying the seawater intrusion index, an index for effectively indicating the rate of seawater intrusion, even in the absence of chloride data in the sample. This addresses limitations encountered in prior art studies.

### SUMMARY

In an exemplary embodiment, the present invention discloses a computer-implemented method for predicting a Seawater intrusion (SWI) index in coastal aquifers in arid regions with a plurality of parameters in groundwater for a sustainable groundwater management. The method includes determining values for each parameter of the plurality of parameters with a sensor network. The method further includes estimating a level of informative contribution of the plurality of parameters and a multicollinearity among the plurality of parameters. The method further includes selecting one or more parameters of the plurality of parameters based on the level of informative contribution and the multicollinearity to obtain an input dataset. The method further includes partitioning the input dataset into a modeling dataset and a testing dataset. The method further includes dividing the modeling dataset into a training set and a validation set. The method further includes tuning a plurality of hyperparameters based on a grid search strategy for a plurality of models. The method further includes training each model of the plurality of models based on the training set and the plurality of hyperparameters. The method further includes evaluating each model of the plurality of models based on the validation set and a plurality of statistical performance metrics. The method further includes selecting a prediction model based on the testing dataset and the plurality of statistical performance. The method further includes predicting the SWI index from the prediction model. The method further includes creating an adaptive groundwater management strategy based on the SWI index.

In another exemplary embodiment, a sustainable groundwater resource management system for predicting a Seawater intrusion (SWI) index with a plurality of parameters in groundwater for a sustainable groundwater management is disclosed. The system includes a processor that is configured to execute a program instruction. The system further includes a storage device that is connected to the processor. The system further includes a chemical parameter monitoring system that is configured to measure a plurality of parameters and send the plurality of parameters to the storage device in one or more coastal aquifers in arid regions. When the program instruction is executed by the processor, the program instruction is configured to perform a method. The method includes determining values for each parameter of the plurality of parameters with a sensor network. The method further includes estimating a level of informative contribution of the plurality of parameters and a multicollinearity among the plurality of parameters. The method further includes selecting one or more parameters of the plurality of parameters based on the level of informative contribution and the multicollinearity to obtain an input dataset. The method further includes partitioning the input dataset into a modeling dataset and a testing dataset. The method further includes dividing the modeling dataset into a training set and a validation set. The method further includes tuning a plurality of hyperparameters based on a grid search strategy for a plurality of models. The method further includes training each model of the plurality of models based on the training set and the plurality of hyperparameters. The method further includes evaluating each model of the plurality of models based on the validation set and a plurality of statistical performance metrics. The method further includes selecting a prediction model based on the testing dataset and the plurality of statistical performance. The method further includes predicting a Seawater intrusion (SWI) index from the prediction model. The method further includes creating an adaptive groundwater management strategy based on the SWI index.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a sustainable groundwater resource management system, according to certain embodiments.

FIG. 2A illustrates a map comprising areas of ground water sample gathering, according to certain embodiments.

FIG. 2B illustrates a pattern of correlation coefficient between predictors and seawater intrusion index, according to certain embodiments.

FIG. 3 illustrates a general machine learning framework for predicting seawater intrusion (SWI) using multiple groundwater parameters, according to certain embodiments.

FIG. 4A illustrates a performance curve of ridge regression model during training stages, according to certain embodiments.

FIG. 4B illustrates a performance curve of the ridge regression model during testing stages, according to certain embodiments.

FIG. 4C illustrates a performance curve of the ridge regression model in predicting the SWI index value compared to an actual SWI index value, according to certain embodiments.

FIG. 4D illustrates a residual plot of the test data in ridge regression model, according to certain embodiments.

FIG. 4E illustrates a Taylor diagram summarizing SWI prediction performance of plurality of models in a presence of chloride data, according to certain embodiments.

FIG. 5A illustrates a performance curve of multilayer perceptron (MLP) model during training stages according to certain embodiments.

FIG. 5B illustrates a performance curve of the MLP model during testing stages, according to certain embodiments.

FIG. 5C illustrates a performance curve of the MLP model in predicting the SWI index value compared to the actual SWI index value, according to certain embodiments.

FIG. 5D illustrates a residual plot of the test data in the MLP model, according to certain embodiments.

FIG. 5E illustrates a Taylor diagram summarizing the SWI prediction performance of plurality of models in absence of chloride data, according to certain embodiments.

FIG. 6 illustrates a flowchart of a computer implement method of predicting a Seawater intrusion (SWI) index in coastal aquifers in arid regions with a plurality of parameters in groundwater for a sustainable groundwater management, according to certain embodiments.

FIG. 7 is an illustration of a non-limiting example of details of computing hardware used in the computing system, according to certain embodiments.

FIG. 8 is an exemplary schematic diagram of a data processing system used within the computing system, according to certain embodiments.

FIG. 9 is an exemplary schematic diagram of a processor used with the computing system, according to certain embodiments.

FIG. 10 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Further, the terms “ML”, “Machine learn” and “Machine learning” represent same terms and used throughout the disclosure synonymously.

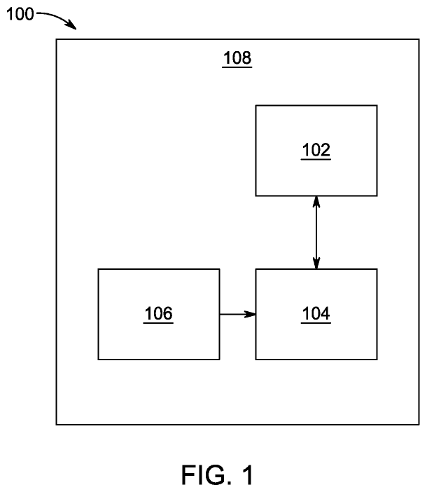

Aspects of this disclosure are directed to a method and a system for predicting seawater intrusion index with multiple parameters in groundwater for sustainable groundwater management. Samples of groundwater coastal region (For example, from the Red Sea and eastern coast of Saudi Arabia) were collected. The sample was identified to determine one or more chemical parameters. An array of machine learning algorithms was trained on one or more chemical parameters for both cases, i.e., when the chloride data is not available to be used for prediction in the groundwater sample and when the chloride data is present in the groundwater sample. Based upon the experimental results, the multilayer perceptron (MLP) model emerged as a best model in identifying the seawater intrusion (SWI) index when the chloride data was not available to be used for prediction. Moreover, the ridge regression model emerged as the best model when the chloride data was present in the groundwater sample. Based on real-time monitoring of the SWI index of groundwater, the system is configured to implement adaptive management strategies. It enables accurate mapping of vulnerable areas to inform authorities associated with groundwater preservation. The detail description of the invention is described in FIG. 1.

FIG. 1 illustrates a portion of a sustainable groundwater resource management system 100, according to an embodiment (elements relating to sampling are not shown). The sustainable groundwater resource management system 100 represents a computing environment to predict a Seawater intrusion (SWI) index in coastal aquifers in arid regions with a plurality of parameters in groundwater for a sustainable groundwater management. In particular, such sustainable groundwater resource management system 100 includes a computing device 108 configured to identify the SWI index of the groundwater. The computing device 108 includes a processor 102 that processes digital data or, in other words, the processor 102 is configured to execute a program instruction. The computing device 108 further includes a storage device 104 that stores the digital data including a code for the program instruction. The storage device 104 is coupled to the processor 102. The computing device 108 further includes a chemical parameter monitoring system 106 coupled to the processor 102. The sensor network 106 is configured to measure a plurality of parameters present in a groundwater sample. The sensor network 106 is further configured to send the plurality of parameters to the storage device 104. In an embodiment, the storage device 104 is located in one or more coastal aquifers in arid regions. In an embodiment, the computing device 108 may refer to a laptop, desktop, iPad, cellphone, computer system at a central server or cloud server, or any computing unit capable of logically analyzing and processing large amounts of digital data. Furthermore, the storage device 104 could be selected from the group containing, but not limited to, hard disk, solid state drive, flash drive, floppy disk, RAM, ROM, Cache, or any storage device currently known in the art.

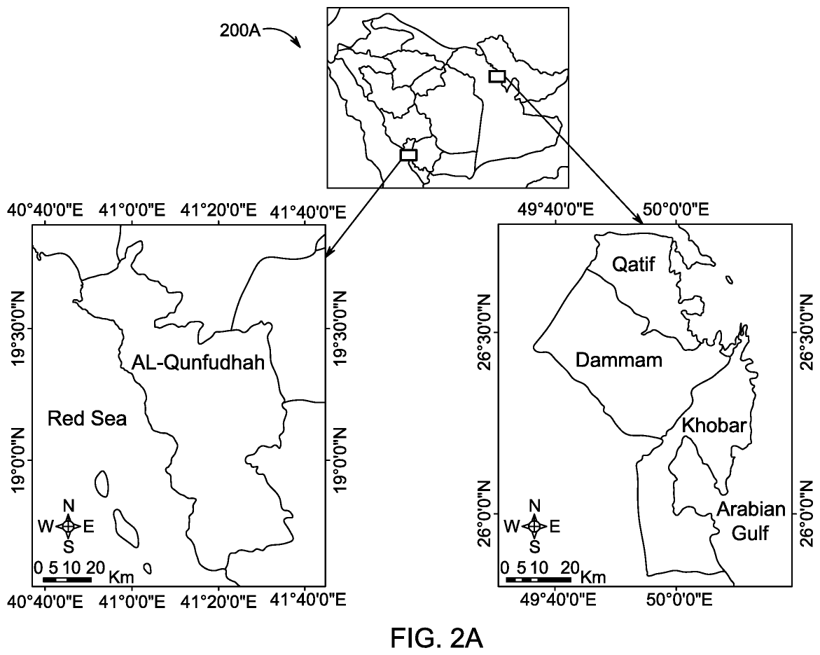

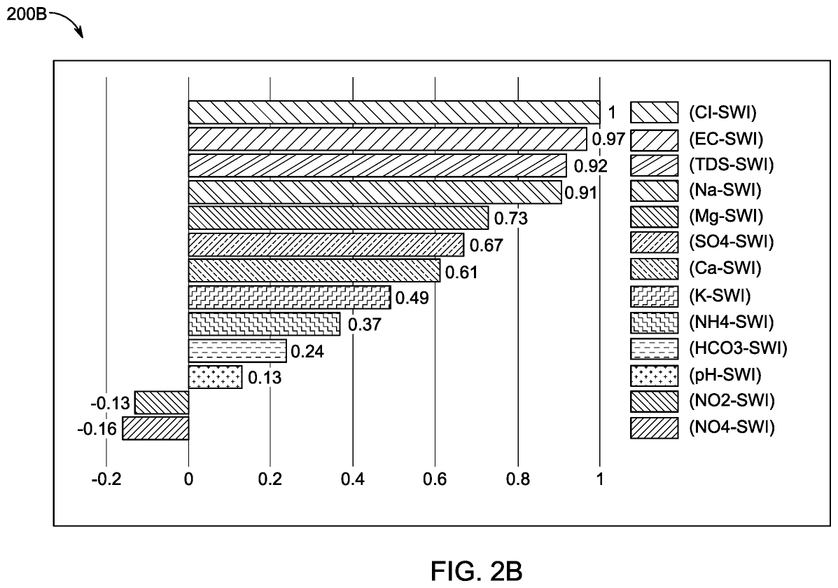

Initially, one or more areas were chosen to collect and examine the groundwater sample. For example, two chosen areas are shown in a map 200A in FIG. 2A where the chosen areas are coastal regions of Saudi Arabia along the Red Sea and eastern coastal region, as shown in two insets, respectively. The chosen areas were used to collect groundwater samples to be examined for identifying the SWI index at two locations. These areas may possibly include the likelihood of water contamination due to seawater intrusion, as these areas are characterized by a variety of sediment deposits, with limestone, sandstone, and shale rock formations being the most prevalent. The distribution, movement, and storage capabilities of groundwater are significantly affected by these geological formations. Geological features also function as channels for water flow and affect groundwater migration. As such, the groundwater sample is collected. However, the chosen area could refer to any coastal region in the world that may have the possibility of water contamination of the groundwater due to seawater intrusion.

The groundwater samples are initially collected using, for example, bailers, peristaltic pumps, double-valve pumps, or any appropriate equipment known in the art. The groundwater sample could be collected manually or automatically. Once samples are collected, the sensor network 106 is configured to store the collected samples in clean containers to prevent contamination. The sensor network 106 is further configured to pass the stored samples through a chamber (not shown) to execute an ion chromatography process to determine the concentration of particular materials such as bicarbonate ion, dissolved solids, nitrate ion, nitrite ion, ammonium ion, chloride ion, sulphate ion, pH, electrical conductivity, calcium ion, magnesium ion, sodium ion, and/or potassium ion or salt thereof that may be present in the groundwater sample. In an embodiment, the chamber (not shown) may be located in the sensor network 106 and refers to a compartment to perform an ion chromatography process on the groundwater samples. In another embodiment, the chamber may be located away from the sensor network 106. To execute the ion chromatography process, the chamber (not shown) may include an ion-exchange column. The ion exchange column includes an ion-exchange resin. The ion-exchange resin selectively retains or releases the water sample ions during the chromatography process. The chamber (not shown) and/or the sensor network 106 are configured to analyze the retention time and peak area and accordingly quantify the groundwater sample. Thus, the ion exchange column is configured to separate and quantify the sample ions by passing the groundwater sample through the ion-exchange column and identify the presence of plurality of parameters of the groundwater sample. As such, the sensor network 106 measures plurality of parameters of a water sample. In an embodiment, the plurality of parameters comprises concentration data, e.g., obtained by measuring the stored samples by ion chromatography, bicarbonate, total dissolved solids (TDS), nitrate, nitrite, ammonium, chloride, sulphate, pH, electrical conductivity (EC), calcium, magnesium, sodium, and potassium or any combination thereof. In an embodiment, measurement of bicarbonate could be done automatically by the sensor network 106 by performing titration and determining the total dissolved solids (TDS) by filtering, evaporating, and weighing the residue. In an embodiment, measurements of bicarbonate could also be done manually by performing the aforementioned process manually. Accordingly, the sensor network 106 measures the presence of the plurality of parameters in the water sample. In an embodiment, sensor network 106 includes, but not limited to an ion chromatography, a pH meter, a TDS meter, a titrator, and a water test kit. In an embodiment, the plurality of parameters may further comprise a climate change parameter and a groundwater extraction scenario, apart from the aforementioned plurality of parameters for identifying the seawater intrusion index present in the sample of the groundwater sample, with or without the presence of chloride data in the sample.

Referring back to FIG. 1, upon measuring the presence of the plurality of parameters, the sensor network 106 sends the plurality of parameters to the storage device 104. In an embodiment, the sensor network 106 generates a dataset of a plurality of parameters and communicates the generated dataset to the storage device 104. The dataset encompasses various chemical parameters necessary for understanding groundwater salinity and seawater intrusion. In an implementation, the storage device 104 may be present at site of one or more coastal aquifers in arid regions or at a remote location.

The computing device 108 is configured to implement a computer-implemented method to predict the seawater intrusion (SWI) index in the groundwater sample. The computer implemented method is executed in the processor 102 of the computing device 108. Once the storage device 104 receives the plurality of parameters, processor 102 of the computing device 108 begins to execute the computer-implemented method where the processor 102 to estimate a level of informative contribution of the plurality of parameters. For example, the processor 102 identifies the salinity or contamination concerns using the plurality of parameters present in the dataset of the water sample. In an embodiment, the processor 102 may also identify the level of presence of each parameter in the groundwater sample. In an embodiment, the computer implemented method could be coded as a computer program product that could be implemented as a software in the computing device 108, such as the laptop, the desktop, the iPad, the cellphone, the computer system at the central server or cloud server, or any computing unit capable of analyzing and processing a large amount of digital data logically. In another embodiment, the computer program product, including the computer-implemented method as disclosed herein, can be stored in a storage device such as compact disks, etc.

The processor 102 is used to identify a multicollinearity among the plurality of parameters present in the dataset. For example, FIG. 2B illustrates a pattern of correlation coefficient 200B between the predictors and seawater intrusion index, according to an embodiment. Here the predictors indicate the 13 parameters and their relationship with the level of the seawater intrusion. Accordingly, the processor 102 identifies the relationship between the plurality of parameters and a predetermined groundwater index beforehand and identifies which parameter out of 13 parameters is highly correlated with the SWI index. For example, patterns of correlation coefficient 200B in FIG. 2B shows that chloride and TDS have strong positive correlations with Electrical conductivity (EC). Additionally, magnesium and sulfate showed favorable correlations with EC. The TDS and chloride are found to be associated with the groundwater correlation index. For example, EC, TDS, and Na may be ranked among the top three with a high correlation to the SWI index.

Referring back to FIG. 1, the processor 102 is used to select one or more parameters of the plurality of parameters based on the level of informative contribution and the multicollinearity to obtain an input dataset. The processor 102 thus prepares two input datasets. For example, during the identification of multicollinearity among the plurality of parameters, the processor 102 identifies that among 13 parameters, the top parameters are Chlorine (Cl), Electrical Conductivity (EC), total dissolved solids (TDS) and Sodium (Na) which showed a high correlation with the Seawater intrusion index (SWI). Accordingly, the processor 102 selects data related to Chlorine (Cl), Electrical Conductivity (EC), total dissolved solids (TDS) and Sodium (Na), their correlation with the seawater intrusion (SWI) index and forms a first input dataset as a sample preparation for plurality of machine learning (ML) models when the chloride (data) is included. On the other hand, during the identification of multicollinearity among the plurality of parameters, the processor 102 identifies that the parameter related to chloride/chloride is not present in the sample. Therefore, the processor 102 identifies that among 12 parameters (i.e., parameter related to chloride is not present), the top parameters as electrical conductivity (EC), total dissolved solids (TDS) and Sodium (Na) which also showed a high correlation with the Seawater intrusion index (SWI) when the chloride data is excluded or not considered. Accordingly, the processor 102 selects data related to the EC, TDS and Na, their correlation with the seawater intrusion (SWI) index and forms a second input dataset as a sample preparation for a plurality of machine learning (ML) models when the chloride (data) is excluded.

Once the processor 102 forms the input dataset with and without the chloride data (i.e., the first and the second input datasets), the processor 102 executes the program instructions stored in the storage device 104 to partition the input dataset into a modeling dataset and a testing dataset for both input datasets, that is, with and without chloride data. Once the processor 102 partitions the input dataset containing the chloride data into the modeling dataset and the testing dataset, the processor 102 executes the code for the program instruction to divide the modeling dataset into a training set and a validation set for the dataset including chloride data. The processor 102 executes the code for the program instructions to divide the modeling dataset into a training set and a validation set for the dataset excluding chloride data.

Since ML algorithms have different capabilities for modelling datasets, processor 102 executes the program instruction to evaluate and investigate a pool of different machine learning (ML) algorithms using the training set and the validation set for both the datasets. The processor 102 executes the program instruction to tune a plurality of hyperparameters based on a grid search strategy for a plurality of models. In some examples, the processor 102 uses a plurality of ML models such as, a Gradient Boosting Regressor, a Multilayer Perceptron, a Ridge Regression, a Decision Tree, a Random Forest, a SVM regression, a Bagging Regressor, a committee regressor, a stacking regressor, or a combination thereof. As such, the processor 102 executes the program instructions to tune hyperparameters of each ML model using the grid search strategy for both the datasets, that is, with and without the chloride data. Table 1 lists the hyperparameters of each ML model.

TABLE 1
Hyperparameter configurations of the machine learning models.

| Model | With Chloride | Without Chloride |
|---|---|---|
| Support Vector Machines | ‘kernel’: ‘linear’ | ‘kernel’: ‘linear’ |
| | ‘C’: 44 | ‘C’: 10 |
| Multilayer Perceptron | ‘activation’: ‘relu’ | ‘activation’: ‘relu’ |
| | ‘learning_rate’: ‘adaptive’ | ‘learning_rate’: ‘adaptive’ |
| | ‘max_iter’: 500 | ‘max_iter’: 10000 |
| | ‘solver’: ‘adam’ | ‘solver’: ‘adam’ |
| | alpha’: 0.001 | alpha’: 0.0001 |
| Ridge Regression | ‘alpha’: 0.01 | ‘alpha’: 50 |
| Gradient Boosting | ‘n_estimators’: 200 | ‘n_estimators’: 500 |
| | ‘learning_rate’: 0.21 | ‘learning_rate’: 0.1 |
| | ‘alpha’: 0.9 | ‘alpha’: 0.9 |
| | ‘max_depth’: 3 | ‘max_depth’: 3 |
| Decision Tree Regression | Criterion: ‘gini’ | Criterion: ‘gini’ |
| Random Forest Regression | ‘n_estimators’: 100 | ‘n_estimators’: 100 |
| Bagging Regression | ‘n_estimators’: 10 | ‘n_estimators’: 10 |

Upon tuning hyperparameters of each machine learning (ML) model using the grid search strategy for both the datasets that is, with and without the chloride data, the processor 102 trains each model of the plurality of models based on the training set and the plurality of hyperparameters. Accordingly, the processor 102 trains the models at two different datasets. For example, the plurality of models includes the gradient boosting regressor model, the multilayer perceptron model, the ridge regression model, the decision tree model, the random forest model, the SVM regression model, the bagging regressor model, the committee regressor model, the stacking regressor model or the combination thereof. The processor 102 trains each ML model using the training set and the plurality of hyperparameters for datasets containing the chloride data. Similarly, the processor 102 also trains each ML model or the combination of models using the training set and the plurality of hyperparameters for datasets excluding the chloride data. In both cases, the training or learning by each ML model may include input and output patterns of 13 or 12 parameters and corresponding SWI index values for each parameter for the groundwater sample for both datasets, respectively.

The processor 102 to compute statistical performance metrics for each ML model in presence of chloride data as well as in absence of the chloride data to evaluate the performance of each ML model on the tested datasets. The evaluation process is executed to identify the performance or efficiency of each of the plurality of models in identifying the SWI index.

There is a plurality of statistical parameters to evaluate the performance of ML models. To execute the evaluation step of multiple ML models for both datasets, the processor 102 inputs the validation set into each ML model and computes a plurality of statistical performance metrics. For example, the processor 102 computes a first statistical performance metric R² for each ML model for the dataset with chloride data using eq (1) for as below:

$${R}^{2} = 1 - \frac{RSS}{TSS} , \qquad ( 1 )$$

where R²=A statistical measure that quantifies the proportion of variance in the dependent variable, which can be explained by the independent variable in an ML model. RSS may refer to the residual sum of squares. The residual sum of squares is computed by the processor 102 using equation (2) as given below:

$$RSS = {\sum }_{i = 1}^{n} {( {y}_{i} - \overline{{y}_{i}} )}^{2} , \qquad ( 2 )$$

where TSS is the total sum of squares. The total sum of squares is computed by the processor 102 using equation (3) as given below:

$$TSS = {\sum }_{i = 1}^{n} {( {y}_{i} - \hat{y} )}^{2} , \qquad ( 3 )$$

yᵢ is i^{th} value to be predicted by the respective ML model, y̅ᵢ̅ is value predicted by the ML model, and ŷ=The mean value of the target data sample.

To comprehend the anticipated prediction losses using a particular ML model, the prediction errors of models are quantified by the processor 102. The processor 102 computes a second statistical performance metrics MSE for each ML model for the dataset with chloride data using eq (4) for as below:

$$MSE = {\sum }_{i = 1}^{n} \frac{{( {y}_{i} - {\overline{y}}_{i} )}^{2}}{n} . \qquad ( 4 )$$

The MSE measures the average of the squares of errors, which assigns more weight to larger errors. Therefore, if the model prediction significantly differs from the actual value, the difference (error) is exaggerated in the accumulated MSE metrics. The processor 102 computes a third statistical performance metrics MAE for each ML model for the dataset with chloride data using eq (5) for as below:

$$MAE = {\sum }_{i = 1}^{n} \frac{\vert {y}_{i} - {\overline{y}}_{i} \vert}{n} \qquad ( 5 )$$

The MAE measures the average magnitude of the errors in a set of predictions without considering their direction. In addition, it is less biased towards larger error values than the MSE. A model achieves high predictive power if the MSE and MAE values are low.

The processor 102 further computes a fourth statistical performance metrics BIC for each ML model for the dataset with chloride data using eq (6) for as below:

$$BIC = 2 log ( n ) k - 2 ln ( L ) . \qquad ( 6 )$$

The BIC measures a trade-off between model complexity and the number of samples required to build the model.

The processor 102 computes a fifth statistical performance metrics AIC for each ML model for the dataset with chloride data using eq (7) for as below:

$$AIC = 2 k - 2 log ( L ) . \qquad ( 7 )$$

The AIC measures the goodness of model fit, favoring simpler models over complex ones. where k is number of features (k=13), L is a likelihood value, and n is number of recorded measurements.

In addition to measuring the aforementioned five statistical performance metrics for each model, the processor 102 monitors the training time of each machine learning model while utilizing datasets that include chloride data.

Table 2 presents a comparative evaluation of the performances of the various models. It was found that while performing the experiments, Linear models, specifically ridge regression and SVM regression, outperformed others primarily because of their effective handling of chloride parameter data. The ridge regression model exhibited an almost negligible MSE, coupled with the lowest values for the AIC and BIC. Table 2 below shows summary of model performance results with chloride data.

TABLE 2
Summary of model performance results with chloride data

| | | | | Training | | |
|---|---|---|---|---|---|---|
| Method | R² | MSE | MAE | Time (s) | AIC | BIC |
| Gradient Boosting | 91.26% | 0.09 | 0.12 | 0.03 | −135.55 | −118.23 |
| Regressor | | | | | | |
| Multilayer Perceptron | 97.47% | 0.03 | 0.13 | 118.98 | −170.21 | −152.89 |
| Ridge Regression | 99.83% | 0.00 | 0.02 | 0.00 | −245.80 | −228.48 |
| Decision Tree | 97.60% | 0.02 | 0.09 | 0.00 | −171.71 | −154.39 |
| Random Forest | 94.20% | 0.06 | 0.11 | 0.05 | −147.05 | −129.73 |
| SVM regression | 99.40% | 0.01 | 0.06 | 0.00 | −210.45 | −193.13 |
| Bagging Regressor | 92.07% | 0.08 | 0.12 | 0.00 | −138.28 | −120.96 |
| Committee Regressor | 98.20% | 0.02 | 0.08 | 0.42 | −179.73 | −162.41 |
| (MLP, SVM regression, | | | | | | |
| Ridge) | | | | | | |
| Stacking Regressor | 99.82% | 0.00 | 0.02 | 0.58 | −244.68 | −227.36 |
| (Gboost, DT, | | | | | | |
| RF, Bagging) | | | | | | |

The processor 102 repeats the evaluation process for each model using datasets that exclude chloride data, based on the validation set and the plurality of statistical performance metrics. Accordingly, the processor 102 further inputs the validation set into each ML model and again computes plurality of statistical performance metrics for the dataset without chloride data. As such, the processor 102 computes a first statistical performance metrics R² for each ML model for the dataset without chloride data using eq (8) for as below:

$${R}^{2} = 1 - \frac{RSS}{TSS} , \qquad ( 8 )$$

where R² is a statistical measure that quantifies the proportion of variance in the dependent variable, which can be explained by the independent variable in an ML model. The residual sum of squares can be computed by the processor 102 using equation (9) as given below:

$$RSS = {\sum }_{i = 1}^{n} {( {y}_{i} - \overline{{y}_{i}} )}^{2} , \qquad ( 9 )$$

where TSS=The total sum of squares. The total sum of squares can be computed by the processor 102 using equation (10) as given below:

$$TSS = {\sum }_{i = 1}^{n} {( {y}_{i} - \hat{y} )}^{2} , \qquad ( 10 )$$

yᵢ=i^{th} value to be predicted by the respective ML model,
y̅ᵢ̅=Value predicted by the ML model,
ŷ=The mean value of the target data sample.

To determine the anticipated prediction losses using a particular ML model, the processor 102 quantifies the prediction errors of models.

The processor 102 computes a second statistical performance metrics MSE for each ML model for the dataset without chloride data using eq (11) for as below:

$$MSE = {\sum }_{i = 1}^{n} \frac{{( {y}_{i} - {\overline{y}}_{i} )}^{2}}{n} . \qquad ( 11 )$$

The processor 102 computes a third statistical performance metrics MAE for each ML model for the dataset without chloride data using eq (12) for as below:

$$MAE = {\sum }_{i = 1}^{n} \frac{\vert {y}_{i} - {\overline{y}}_{i} \vert}{n} . \qquad ( 12 )$$

The processor 102 computes a fourth statistical performance metrics BIC for each ML model for the dataset without chloride data using eq (13) for as below:

$$BIC = 2 log ( n ) k - 2 ln ( L ) . \qquad ( 13 )$$

The processor 102 computes a fifth statistical performance metrics AIC for each ML model for the dataset without chloride data using eq (14) for as below:

$$AIC = 2 k - 2 log ( L ) . \qquad ( 14 )$$

The AIC measures the goodness of model fit, favoring simpler models over complex ones. Here k=number of features (k=12 as chloride parameter is excluded), L=Likelihood value, and n=number of recorded measurements.

In addition to measuring the aforementioned five statistical performance metrics for each model, the processor 102 monitors the training time of each machine learning model while utilizing datasets that exclude the chloride data.

Considering both cases (that is, with or without chloride data), it was observed that the ridge regression model performed well because of the other predictors (TDS, EC, and sodium) that were highly correlated with the SWI. However, the MLP algorithm achieved a slightly better performance in terms of R² even when the parameter did not include the chloride data. In addition, by considering the AIC and BIC computed for both models (ridge regression and MLP), the MLP achieved the best results against all models. However, MLP requires a longer training time. The summary of model performance is given in Table 3.

TABLE 3
Summary of model performance results without chloride data

| | | | | Training | | |
|---|---|---|---|---|---|---|
| Method | R² | MSE | MAE | Time (s) | AIC | BIC |
| Gradient Boosting | 95.10% | 15.11 | 1.69 | 0.11 | 6.73 | 22.72 |
| Regressor | | | | | | |
| Multilayer Perceptron | 98.70% | 4.01 | 1.43 | 11.02 | −30.45 | −14.46 |
| Ridge Regression | 98.60% | 4.32 | 1.49 | 0.00 | −28.35 | −12.36 |
| Decision Tree | 90.94% | 27.95 | 2.47 | 0.00 | 23.95 | 39.93 |
| Random Forest | 93.87% | 18.91 | 1.89 | 0.05 | 13.02 | 29.00 |
| SVM regression | 96.47% | 10.90 | 2.06 | 0.00 | −2.43 | 13.56 |
| Bagging Regressor | 93.34% | 20.55 | 2.06 | 0.00 | 15.33 | 31.32 |
| Committee | 98.53% | 4.54 | 1.49 | 10.77 | −26.95 | −10.96 |
| Regressor (MLP, | | | | | | |
| SVM regression, | | | | | | |
| Ridge) | | | | | | |
| Stacking Regressor | 98.65% | 4.18 | 1.41 | 1.02 | −29.27 | −13.29 |
| (Gboost, DT, | | | | | | |
| RF, Bagging) | | | | | | |

Based upon the validation set and the plurality of statistical performance metrics, the processor 102 evaluates each model for the datasets, excluding the chloride data. It was observed that, in the absence of chloride data, the MLP model retains high accuracy.

After evaluating each ML model based on the validation set and a plurality of statistical performance metrics for both type of datasets, the processor 102 selects a prediction model based on a testing dataset and the plurality of statistical performance. The prediction model refers to a final ML model that can predict the SWI index of the groundwater merely by knowing the plurality of parameters of the groundwater, such as EC, TDS, and Na in case the chloride data is not available. Also, when the chloride data is available, the final ML model would refer to one that could easily predict the SWI index of the groundwater merely by knowing the plurality of parameters of the groundwater, such as Cl, EC, TDS, and Na. Accordingly, the selection process of the preferred prediction model further includes a ranking process of the plurality of ML models for both cases (that is, with or without chloride data).

Identification of best model performance is described herein. The ranking process involves assigning a rank or a quality metric to each machine learning model based on its performance in the statistical performance metrics when chloride data is not present. In order to rank the plurality of ML models, the processor 102 is used to determine the performance of a plurality of ML models as provided in Table 2 when the chloride data is not available in the groundwater sample. The processor 102 is used for the datasets without chloride data and identifies the rank of each ML model based upon their performance during the statistical performance metrics. The processor 102 then assigns the rank to each ML model accordingly. The rank could be either in ascending or descending order. For example, Gradient boosting model could be assigned rank 1, Ridge regression model could be assigned rank 4, etc.

Based upon the rank, the processor 102 is configured to identify the best ML model that outperformed during their evaluation step. ML models with best performance is assigned highest rank such as Rank 1 whereas ML models with lowest or least performance are assigned lower ranks, such as Rank N.

Here N=total number of ML model evaluated using statistical performance metrics=9 Since the total number of ML models used are 9. The processor 102 selects the top performing model (that is, model with rank 1) as the best performing model and stores it in a stack of best model performance. The model with Rank 1 is to be used as a prediction model for identifying the SWI index of the groundwater when the Chloride data is not present.

Identification and formation of model committee of top three ML models is described herein. Based upon ranks assigned to plurality of ML models by the processor 102, the processor 102 creates another stack comprising a committee of models. The committee of models includes those top three models or the preferred ML models which could identify the SWI index by integrating the prediction power of the selected top three models. For example, models with rank 2, 3 and 4 could be placed in the committee of models as committee of the top 3 models with higher ranks. In another example, models with rank 4, 1 and 2 could be placed in the committee of models. In another example model with rank 1, 7 and 8 could be placed in the committee of models. The processor 102 needs to identify the top three models that could be placed in the committee of models.

In order to identify top three models, the processor 102 calculates an arithmetic average of the at least three predictions in predicting the SWI indexes by each ML model having rank 2-9. The processor 102 evaluates which three models could easily determine the SWI index by integrating the prediction powers of the three Models. As such, the processor 102 evaluates the arithmetic average of each model having rank 2-9 and identifies the top three models based upon the integration of the prediction power of the three model. Based upon the result of arithmetic average, the processor selects the top three models as the committees of model. In an example, the selected top three committee of models could include model with rank 2, 8, 9. In another embodiment, the selected top three committee of models could include models with rank 3, 2, 8. In another embodiment, the selected top three committee of models could include models with rank 2, 7, 8. As such, based upon the arithmetic average of three models, integrating the prediction powers of the top three models and aggregating the forecasts of the committee models by using the arithmetic averages of the three predictions, the processor 102 identifies the top three models. The processor 102 selects the top three model (for example, Model with rank 2, 3, 8) and stores it in the stack of committee of models. The stack of committee of models (for example, models with rank 2, 3 and 8) is to be used as a prediction model for identifying the SWI index of the groundwater when the chloride data is not present. The three models are considered as a set of preferred models.

Identification and formation of model stack of weaker models is described herein. Based upon the rank assigned to plurality of ML models over performance during evaluation step, the processor 102 creates another stack comprising a stack of models. The stack of models includes those at least four weak models or the second-preferred ML models which could identify the SWI index by chaining the predictions of weaker models of the selected 4 weaker models. For example, models with rank 2, 4, 7 and 8 could be placed in the stack of models as stack of four weaker models. In another example, models with rank 2, 9 and 3 and 5 could be placed in the stack of models. In another example model with rank 3, 5, 7 and 8 could be placed in the stack of models. The processor 102 is configured to identify the four weaker models that could be placed in the stack of models.

In order to identify four weaker models, the processor 102 sorts the models in either ascending or descending order based upon their assigned rank during the evaluation process. Upon sorting, the processor 102 to creates a stack of models.

Now the processor 102 creates a stacking validation set based on the plurality of SWI indexes obtained from the stack of models and the validation set and randomly selects 4 weak models, that is, those models who had a lower performance in identifying the SWI index during training. In an embodiment, the stack of weak models could be models with rank 4, 5, 6, and 7. In another embodiment, the stack of weak models could be models with rank 2, 7, 8, and 9. In another embodiment, the stack of four weak models could be models with rank 3, 4, 5, and 6. The processor 102 trains the combination of four weak models and testes the efficiency of the four models using the stacking validation set. Whichever combination of models (for example, models with rank 3, 4, 5 and 6) performs with high efficiency in effectively identifying the SWI index by chaining the predictions of weaker models, the processor 102 identifies those four weaker models and stores them in the stack of four weak models. The processor 102 thus selects the set of weaker 4 models (for example, model with rank 3, 4, 5, 6) as a final prediction model and stores it in the stack of models. The stack of models (for example, models with rank 3, 4, 5 and 6) is to be used as the prediction model for identifying the SWI index of the groundwater when the chloride data is not present. The four weak models are considered as the set of second-preferred models.

Upon identifying the best model, the committee of models and the stack of models based upon the rank, the processor 102 has three prediction models to be used for identifying the SWI index of the ground water when the chloride data is not present. Now the processor 102 is configured to identify the best candidate model. The best candidate model refers to the prediction model to be finally selected as a trained final prediction model for predicting the SWI index of the groundwater when the chloride data is not present. The trained final prediction model could be selected from the best performing model or from the committee of stack of 3 ML models or from the stacking of models of 4 weaker models. At this time, in order to select the trained final prediction model out of the three different stacks, the processor 102 to selects all three models and apply the testing datasets on the three models to identify their performance in identifying the SWI index over the testing datasets. The processor 102 thus selects the prediction model out of the three prediction models as the one which outperforms in predicting the SWI index. Accordingly, the processor 102 selects the prediction model from the group consisting of the plurality of models, the committee of models, and the stack of models based on the rank, when the chloride data is not present. It was experimentally found that the processor 102 selected, out of the models in three stacks (that is, best performing model, committee of models and stack of models), the MLP model as the prediction model or the trained final prediction model based on the goodness of model fit and the predicting power of the model. The MLP model was selected based on the testing dataset and the plurality of statistical performance when the chloride data is not present. The MLP model was found to outperform while applying the testing dataset. The MLP model accurately identified the SWI index of the groundwater the processor 102.

Further, the processor 102 selects the prediction model (that is, MLP model, for example) when the chloride data is not present. The computing device 108 of the sustainable groundwater resource management system 100 is provided with the sample of the groundwater to analyze the real time SWI index. The processor 102 of the computing device 108 analyzes the plurality of parameters. If the processor 102 identifies that the chloride data is not available in plurality of parameters, the processor 102 selects the MLP model to identify the SWI index from plurality of parameters.

The similar procedure is again followed by the processor 102 as described previously when chloride data is available. The process of identification of best model performance, identification and formation of model committee and identification and formation of model stack of weaker models is not repeated herein. By repeating the same process as described earlier, the processor 102 selects the top performing model (that is, model with rank 1) as the best performing model and stores it in a stack of best model performance. The model with Rank 1 is to be used for identifying the SWI index of the groundwater when the Chloride data is present. By repeating the similar process, the processor 102 selects the top three model (for example, model with rank 2, 3, and 8) and stores it in a stack of committee of models. The stack of committee of models (for example, models with rank 2, 3 and 8) is to be used for identifying the SWI index of the groundwater when the chloride data is present. The three models are considered as a set of preferred models.

By repeating the similar process, the processor 102 selects the set of weaker 4 models (for example, Model with rank 3, 4, 5, and 6) as a final prediction model and stores it in a stack of models. The stack of models (for example, models with rank 3, 4, 5 and 6) as the final prediction model is to be used for identifying the SWI index of the groundwater when the chloride data is present. The four weak models are considered as the set of second-preferred models.

Upon identifying the best model, the committee of models and the stack of models based upon the rank, the processor 102 has three prediction models to be used for identifying the SWI index of the ground water when the chloride data is present. Now the processor 102 is configured to identify the best candidate model. The best candidate model refers to the model to be finally selected as a trained final prediction model for predicting the SWI index of the groundwater when the chloride data is present. The trained final prediction model could be selected from the best performing model or from the committee of stack of 3 ML models or from the stacking of models of 4 weaker models. At this time, in order to select the trained final prediction model out of the three stacks, the processor 102 to selects all three models and apply the testing datasets on the three models to identify their performance in identifying the SWI index over the testing datasets. The processor 102 thus selects the prediction model out of the three prediction models as the one which outperforms in predicting the SWI index. Accordingly, the processor 102 selects the prediction model from the group consisting of the plurality of models, the committee of models, and the stack of models based on the rank, when the chloride data is present. It was experimentally found that the processor 102 selected, out of the models in three stacks (that is, best performing model, a committee of models and stack of models), the Ridge regression model as the prediction model, based on the goodness of fir and the predicting power of the model. The Ridge regression model was selected based on dataset and the plurality of statistical performance when the chloride data is present. The Ridge regression model was found to outperform while applying the testing dataset. The Ridge regression model accurately identified the SWI index of the groundwater.

Further, the processor 102 selects the prediction model (that is, Ridge regression model for example) when the chloride data is present. The computing device 108 of the sustainable groundwater resource management system 100 is provided with the sample of the groundwater to analyze the real time SWI index. The processor 102 of the computing device 108 analyzes the plurality of parameters. If the processor 102 now identifies that the chloride data is available in plurality of parameters of the groundwater sample, the processor 102 selects the Ridge regression model to identify the SWI index from plurality of parameters.

Considering both cases that is, when the chloride data is not present in the groundwater sample and when the chloride data is present in the groundwater sample, the processor 102 is configured to select the MLP model and the Ridge regression model, respectively, to be used as the final prediction model which is identified as the best ML model during testing datasets for both cases. During experimentation, it was found that the identified prediction model was the Ridge regression model that outperformed compared to other models when the plurality of parameters consists of bicarbonate, TDS, nitrate, nitrite, ammonium, chloride, sulphate, a pH, an electrical conductivity, calcium, magnesium, sodium, potassium. In other words, when the chloride data is available, the processor 102 selects the identified ML model, for example, the ridge regression model in order to identify the real time SWI index of the groundwater. On the other hand, it was also found during experiment that the identified prediction model was the Multilayer Perceptron (MLP) model that outperformed compared to other models when the plurality of parameters consists of bicarbonate, a total dissolved solids (TDS), nitrate, nitrite, ammonium, sulphate, a pH, an electrical conductivity, calcium, magnesium, sodium, potassium. In other words, when the chloride data is not present, the processor 102 selects, for example, the MLP model to identify the real time SWI index of the groundwater.

Accordingly, the processor 102 only needs to identify plurality of parameters and presence or absence of the chloride data in the groundwater sample. Based upon the presence or absence of the chloride data in the groundwater sample, the processor 102 selects the prediction model such as either the MLP model or the Ridge regression model. Using the MLP model, when the chloride data is not present, the processor 102 to predict the SWI index using the MLP model. The MLP model monitors the pattern of plurality of parameters present in the water sample and fits the data learned during training and identifies the exact value of SWI index of the groundwater. Similarly, using the Ridge regression model, when the chloride data is present, the processor 102 to predict the SWI index using the Ridge regression model. The ridge regression model monitors the pattern of plurality of parameters present in the water sample and fits the data learned during training and identifies the exact value of SWI index of the groundwater.

In another embodiment, once the seawater intrusion index is determined in the groundwater sample, the processor 102 may create an adaptive groundwater management strategy based on the level of the SWI index. For example, the based upon the level of SWI index, the computing device 108 may transmit an alert or SOS notification to a water management authority to take the necessary step. The necessary step may include “Inform the nearby people” when the SWI index has approached below threshold. Additionally, the necessary step may include “Collect water sample every hour” during the alert period. The computing device 108 may include a wired or wireless communication module to transmit the alert message when the SWI index dips below a predefined threshold. In another embodiment, water samples from aquifers near coastal regions may be collected at specified intervals, such as every few minutes, hours, days, or months, automatically by the sensor network 106. The monitored parameters are then transmitted to the storage device 104 for SWI index level analysis by the processor 102. In one embodiment, the computing device 108 can be programmed to transmit alert messages to residents near the aquifer in coastal regions where groundwater samples are examined. In this scenario, the computing device 108 may be programmed to send alert messages to a cloud server (not shown). The cloud server (not shown) can determine the location of residents near the aquifer along the coastal region and send them alert messages, providing information about the current SWI index conditions and possibly solutions to tackle the current situation. In another embodiment, ML models of the computing device 108 can accurately map vulnerable areas and inform the creation of adaptive strategies to the local authorities. By incorporating additional parameters, such as the climate change and extraction scenarios, the prediction model could effectively identify the SWI index under a wide range of conditions, thereby facilitating more effective long-term strategies for groundwater resource management.

In another embodiment, the processor 102 of the present invention may every time collect the plurality of parameters of the groundwater near aquifers and identify the best ML model each time the parameter is identified. The plurality of parameters is transmitted to the computing device 108. Based upon the plurality of parameters that shows a high correlation of the SWI index with the plurality of parameters, the processor 102 of the computing device 108 performs the aforementioned computer implemented method to again identify a real-time optimum prediction model appropriate for the plurality of parameters and identification of SWI index. Once the best ML model is identified, the processor 102 may in real-time select the best model to identify the SWI index. As such, even if the number of parameter changes or new parameters are identified, or only few parameters are identified that shows high correlation with the SWI index value, the processor 102 may easily perform the model building and learning the pattern of the parameters with respect to the SWI index value and accordingly train the model in real-time to identify the current SWI index of the groundwater sample.

Thus, the processor 102 requires knowledge of at least three parameters of groundwater sample, such as EC, TDS, and Na, to identify the seawater intrusion (SWI) index in cases where chloride data is not available. Additionally, if chloride data is present, the invention only needs knowledge of four parameters: Cl, EC, TDS, and Na, to identify the seawater intrusion (SWI) index. Consequently, the limitation of requiring chloride data every time to identify the SWI index, as present in the prior art, is eliminated by the method disclosed in the current invention. The present invention could easily identify the SWI index of the groundwater even if the chloride data is unavailable.

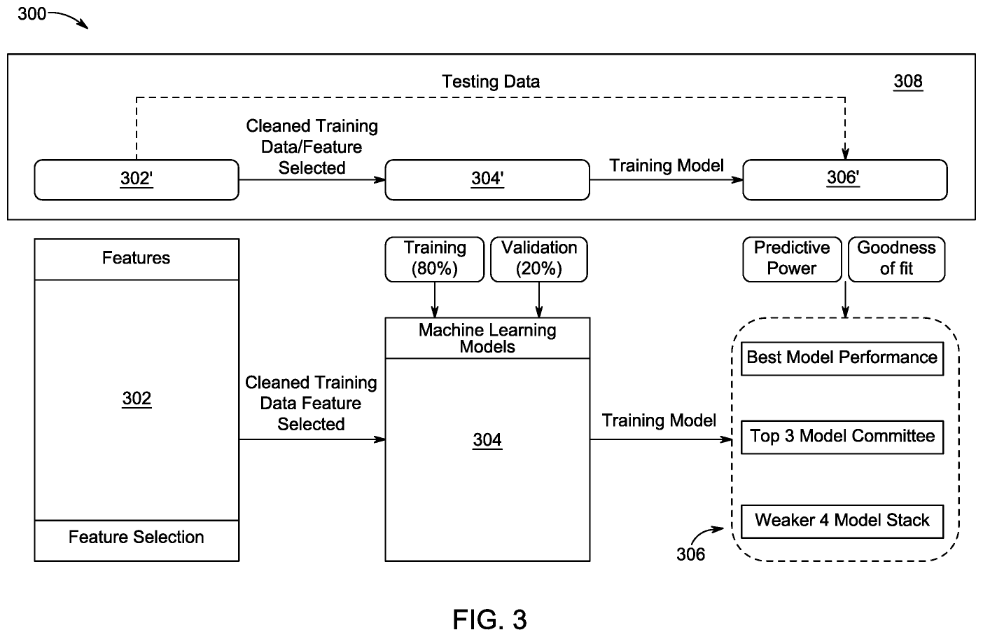

FIG. 3 illustrates a general machine learning framework 300 for predicting SWI using multiple ground water parameters, according to an embodiment. The framework 300 is executed as a computer implemented method in the processor 102 of the computing device 108 in FIG. 1. The framework 300 begins with data collection and feature selection step 302. The feature selection step 302 includes transferring plurality of parameters by the sensor network 106 to the storage device 104 of the computing device 108. Similarly, a computing environment 308 of the processor 102 shows the feature selection step 302′ that illustrates transferring the selected feature and parameters to the processor 102 to train the plurality of ML models 304′ using 80% training data. The plurality of parameters consists of bicarbonate, a total dissolved solids, nitrate, nitrite, ammonium, chloride, sulphate, a pH, an electrical conductivity, calcium, magnesium, sodium, and potassium that includes the chloride data. In another embodiment, the plurality of parameters consists of bicarbonate, a total dissolved solids, nitrate, nitrite, ammonium, sulphate, a pH, an electrical conductivity, calcium, magnesium, sodium, and potassium that does not include the chloride data. The number of parameters in each case are used as a sample preparation for ML models 304. Also, at this stage, features of the modelling dataset is analyzed by the processor 102 to estimate their level of informative contribution in building better ML prediction models. In addition, the collinearity levels among features are also analyzed for feature selection purposes. Once features are analyzed, the selected features and plurality of parameters is transferred to the Machine learning and building block for ML models 304, where the data corresponding to plurality of parameters and its correlation with SWI index is split into training dataset (80%) and testing dataset (20%). Based upon 80% training data and learning by plurality of ML models, the processor 102 forwards the trained models to an analysis block 306 within the processor 102. The computing environment 308 of the processor 102 also shows transferring trained models to the analysis block 306′. The processor 102 is configured to identify a best performing model based upon the rank of the model and store in a stack of best model performance. The processor 102 is further configured to build a model committee including at least three best ML models and a stack of 4 weaker model. The best three models are considered as preferred models that outperformed in exactly analyzing the SWI index. Also, the committee of models is formed by integrating the prediction power of the top three models. The stack of 4 models is considered as second preferred models where chaining of predictions of weaker models contributed to exactly identify the SWI index. The models in all three sections, that is the best performing models, committee of models and stack of models are tested on the training dataset to identify and select a final preferred model for determining the SWI index of the groundwater. The computing environment 308 also shows the final prediction model selection as in an analysis block 306′. During experiment, the ridge regression model was identified as the final prediction model for identifying the SWI index when the plurality of parameters includes the Chloride data. Also, the MLP model was identified as the final prediction model for identifying the SWI index when the plurality of parameters does not include the chloride data. Based upon the final prediction model selection, the processor 102, using the predictive power of the selected ML model (that is, either MLP model or the ridge regression model) identifies the SWI index of the groundwater.

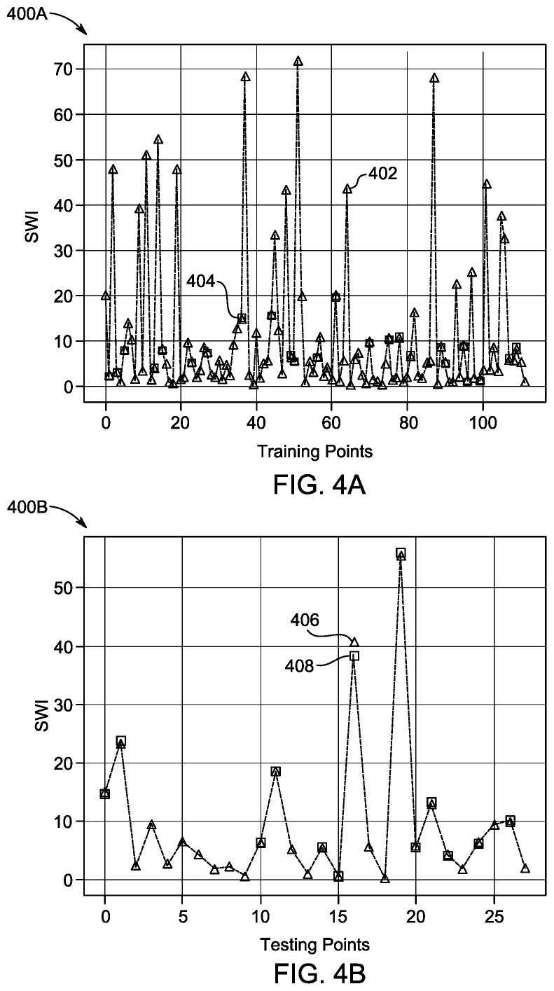

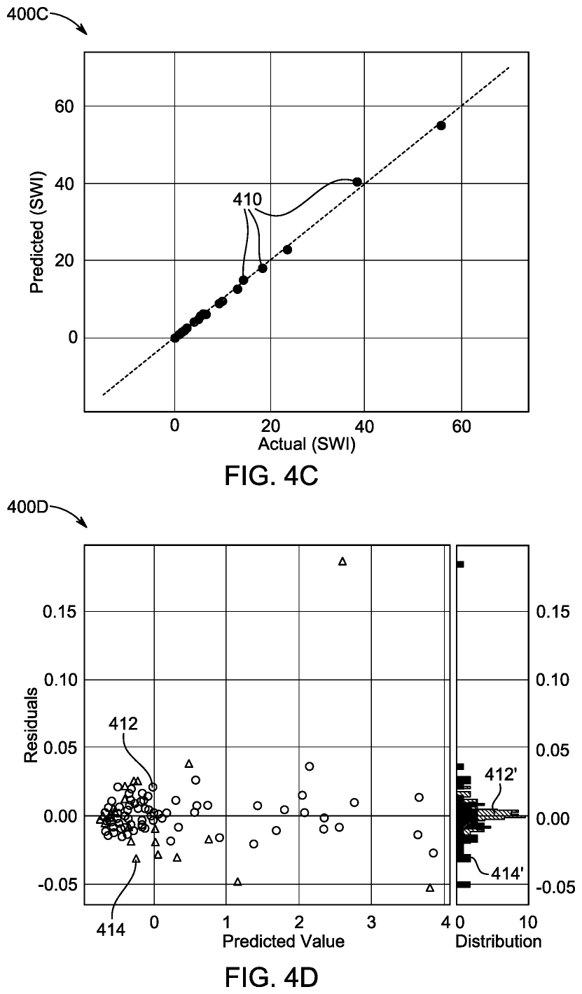

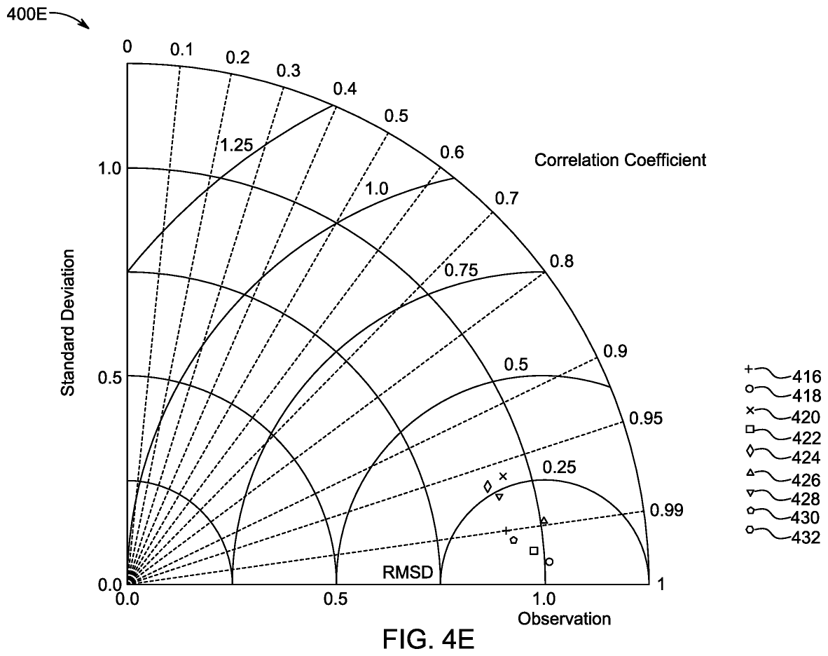

FIG. 4A illustrates a performance curve 400A of the ridge regression model during training stages, according to an embodiment. A plot 402 indicates actual SWI index value of the groundwater sample, whereas a plot 404 indicates the predicted SWI index value of the groundwater. The overlapping of the plots indicate that the ridge regression model performed quite well in fitting points and predicting the SWI index value during training, when the chloride data was present in the groundwater sample.

FIG. 4B illustrates a performance curve 400B of the ridge regression model during testing stages, according to an embodiment. A plot 408 indicates actual SWI index value of the groundwater sample, whereas a plot 406 indicates the predicted SWI index value of the groundwater. The overlapping of the plots again indicate that the ridge regression model performed quite well in predicting the SWI index value on the groundwater sample during testing, when the chloride data was present in the groundwater sample.

FIG. 4C illustrates a performance curve 400C of the ridge regression model in predicting the SWI index value compared to the actual SWI index value, according to an embodiment. Plot 410 indicates the predicted SWI index value of the groundwater sample, which almost fits over the actual value of the SWI index. The plot 410 confirms the accuracy of the ridge regression model in predicting the SWI index value in presence of the chloride data.

FIG. 4D illustrates a residual plot 400D of the test data in ridge regression model, according to an embodiment. A plot 412 indicates R² value at 1.000 during training whereas a plot 414 indicates R² value at 0.998 during testing at the prediction value by the ridge regression model. The distribution set also shows the distribution curves of R² value at 1.000 as a plot 412′ whereas the distribution set also shows the distribution curves of R² value at 0.998 as a plot 414′. The residual plot 400C also confirmed the normality and homoscedasticity of the dataset.

FIG. 4E illustrates a Taylor diagram 400E summarizing the SWI prediction performance of plurality of models in presence of chloride data, according to an embodiment. Points 416, 418, 420, 422, 424, 426, 428, 430 and 432 indicate standard deviation of the MLP model, Ridge regression model, Gboost model, SVM regression model, Bagging model, decision tree model, random forest model, committee model, stacking model, respectively.

Considering FIGS. 4A, 4B, 4C, 4D and 4E, it was observed that the models were able to explain 95-99% of the variations in the SWI, as indicated by the R². In addition, most models required less than 1 s to build. The MLP was the found to be the slowest model that took approximately 9.81 s to build the model. Also, the Taylor diagram shows that the ridge regression, SVM regression, and stacking model predictions have greater than 0.99 correlations with the actual SWI and the lowest MSEs.

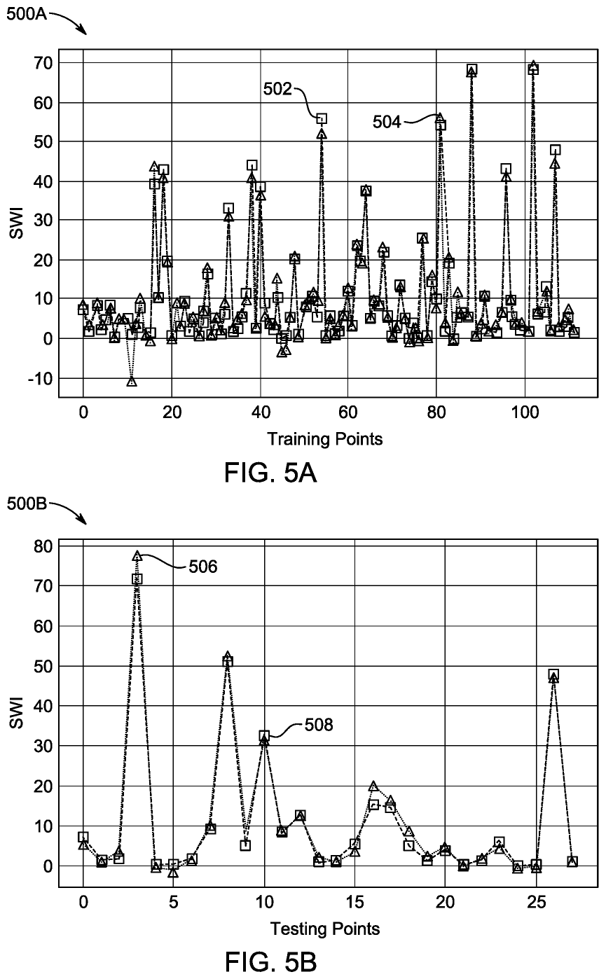

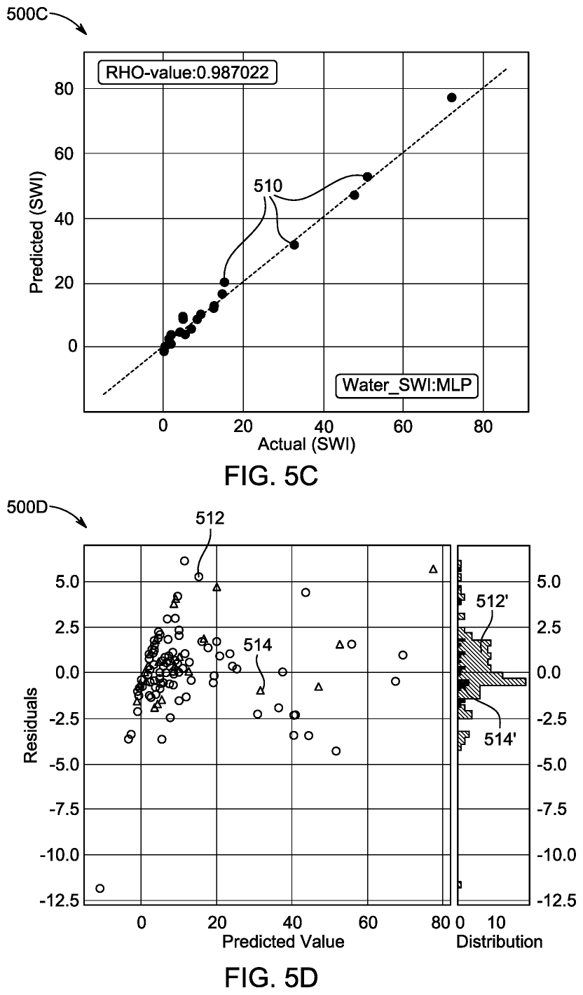

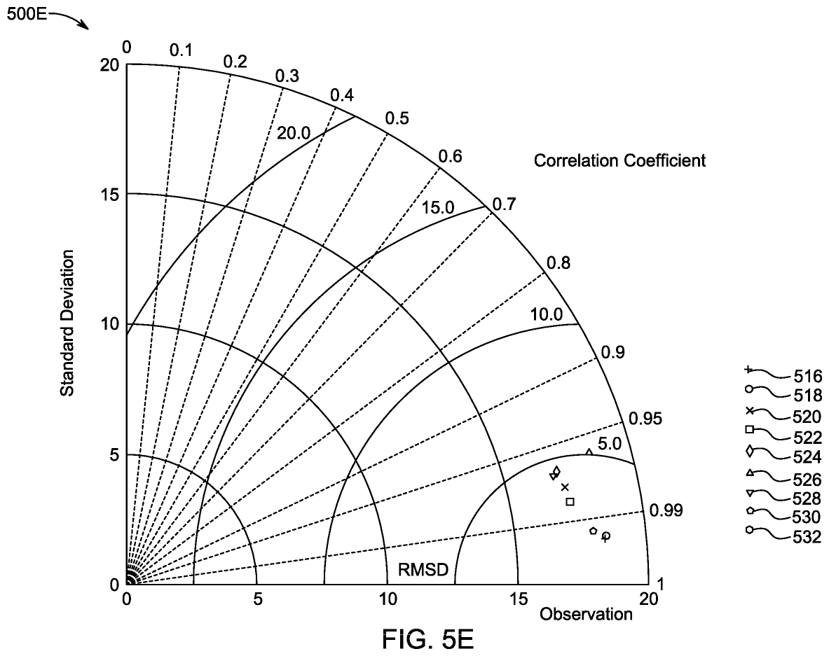

FIG. 5A illustrates a performance curve 500A of the MLP model during the training stages according to an embodiment. A plot 502 indicates actual SWI index value of the groundwater sample, whereas a plot 504 indicates the predicted SWI index value of the groundwater. The overlapping of plots indicates that the MLP model performed quite well in fitting points during training and predicting the SWI index value during training even when the chloride data was not present in the groundwater sample.

FIG. 5B illustrates a performance curve 500B of the MLP model during testing stages, according to an embodiment. A plot 508 indicates actual SWI index value of the groundwater sample, whereas a plot 506 indicates predicted SWI index value of the groundwater. The overlapping of the plots again indicates that the MLP model performed quite well in prediction samples during testing, when the chloride data was not present in the groundwater sample.

FIG. 5C illustrates a performance curve 500C of the MLP model in predicting the SWI index value compared to the actual SWI index value, according to an embodiment. A plot 510 indicates predicted SWI index value of the groundwater sample, which almost fits over the actual value of the SWI index. As shown in the FIG. 5C that although, some samples were found to be deviated from the reference line, the plot 510 confirms the accuracy of the MLP model in predicting the SWI index value even in the absence of the chloride data.

FIG. 5D illustrates a residual plot 500D of the test data in the MLP model, according to an embodiment. A plot 512 indicates R² value at 0.979 during training whereas a plot 514 indicates R² value at 0.987 during testing at the prediction value by the MLP model. The distribution set shows distribution curves of R² value at 0.979 as a plot 512′ whereas the distribution set also shows distribution curves of R² value at 0.987 as a plot 514′. The deviation of the sample points observed in FIG. 5D was confirmed in FIG. 5C also.

FIG. 5E illustrates a Taylor diagram 500E summarizing the SWI prediction performance of plurality of models in absence of chloride data, according to an embodiment. Points 516, 518, 520, 522, 524, 526, 528, 530 and 532 indicate standard deviation of the MLP model, Ridge regression model, Gboost model, SVM regression model, Bagging model, decision tree model, random forest model, committee model, stacking model, respectively. The Taylor diagram 500E showed that the MLP and ridge regression models almost achieved similar performances, with model predictions more than 0.99 correlation values with the actual SWI and the lowest MSEs.

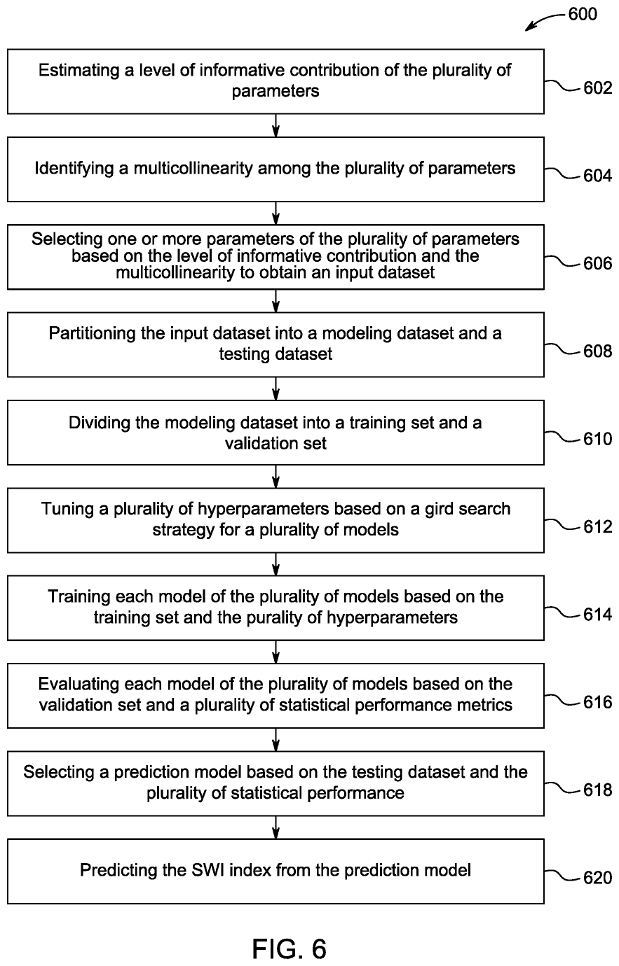

FIG. 6 illustrates a flowchart of a computer implement method 600 of predicting a Seawater intrusion (SWI) index in coastal aquifers in arid regions with a plurality of parameters in groundwater for a sustainable groundwater management, according to an embodiment. The method is performed as a computer implemented method in the processor 102 of the computing device 108 as described in FIG. 1. The method 600 is described in conjunction with FIGS. 1-3 and various experimental observation in FIGS. 4-5. Various steps of the method 600 are included through blocks in FIG. 6. One or more blocks may be combined or eliminated to achieve the method for predicting a Seawater intrusion (SWI) index in coastal aquifers in arid regions with a plurality of parameters in groundwater for a sustainable groundwater management, without departing from the scope of the present disclosure.

At step 602, the method 600 includes, estimating a level of informative contribution of the plurality of parameters. The plurality of parameters comprises bicarbonate, a total dissolved solids, nitrate, nitrite, ammonium, chloride, sulphate, a pH, an electrical conductivity, calcium, magnesium, sodium, potassium, or any combination thereof, present in the groundwater sample. In another embodiment, the plurality of parameters comprises bicarbonate, a total dissolved solids, nitrate, nitrite, ammonium, sulphate, a pH, an electrical conductivity, calcium, magnesium, sodium, potassium, or any combination thereof, present in the groundwater sample.

At step 604, the method 600 includes identifying a multicollinearity among the plurality of parameters.

At step 606, the method 600 includes selecting one or more parameters of the plurality of parameters based on the level of informative contribution and the multicollinearity to obtain an input dataset.

At step 608, the method 600 includes partitioning the input dataset into a modeling dataset and a testing dataset.

At step 610, the method 600 includes dividing the modeling dataset into a training set and a validation set;

At step 612, the method 600 includes tuning a plurality of hyperparameters based on a grid search strategy for a plurality of models. The plurality of models is a Gradient Boosting Regressor, a Multilayer Perceptron, a Ridge Regression, a Decision Tree, a Random Forest, a SVM regression, a Bagging Regressor, a committee regressor, a stacking regressor, or a combination thereof.

At step 614, the method 600 includes training each model of the plurality of models based on the training set and the plurality of hyperparameters.

At step 616, the method 600 includes evaluating each model of the plurality of models based on the validation set and a plurality of statistical performance metrics.

At step 618, the method 600 includes selecting a prediction model based on the evaluation from the step 616, the testing dataset and the plurality of statistical performance.

At step 620, the method 600 includes predicting the SWI index from the prediction model.

In some embodiments, the method 600 further includes creating an adaptive groundwater management strategy based on the SWI index (not shown). The adaptive groundwater management strategy includes, but not limited to, ponding surface water and stormwater runoff, using river water to recharge the groundwater table, promoting water conservation, and restricting withdrawals from coastal aquifers using recharge wells and/or deep recharge wells.

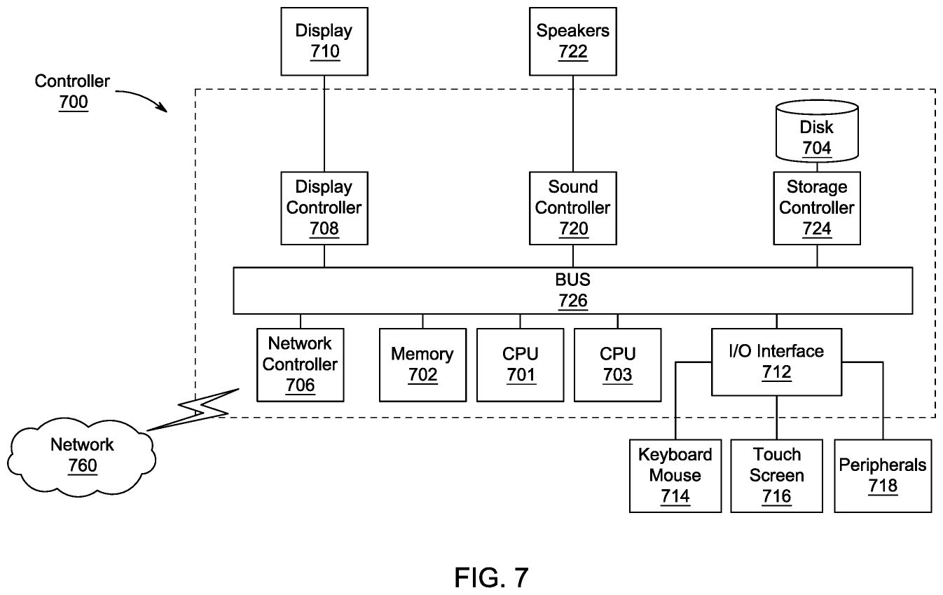

Next, further details of the hardware description of the computing environment according to exemplary embodiments is described with reference to FIG. 7. In FIG. 7, a controller 700 described is representative of the computing device 108 of FIG. 1 in which the controller 700 is a computing device which includes a CPU 701 which performs the processes described above/below. The process data and instructions may be stored in memory 702. These processes and instructions may also be stored on a storage medium disk 704 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 701, 703 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 701 or CPU 703 may be a Xenon or Core processor from Intel of America or an Opteron processor from AMD of America, or may be other processor types that would be recognized by one of ordinary skill in the art. Alternatively, the CPU 701, 703 may be implemented on an FPGA, ASIC, PLD or using discrete logic circuits, as one of ordinary skill in the art would recognize. Further, CPU 701, 703 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with network 760. As can be appreciated, the network 760 can be a public network, such as the Internet, or a private network such as an LAN or WAN network, or any combination thereof and can also include PSTN or ISDN sub-networks. The network 760 can also be wired, such as an Ethernet network, or can be wireless such as a cellular network including EDGE, 3G, 4G and 5G wireless cellular systems. The wireless network can also be Wi-Fi, Bluetooth, or any other wireless form of communication that is known.

The computing device further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the computing device such as Sound Blaster X-Fi Titanium from Creative, to interface with speakers/microphone 722 thereby providing sounds and/or music.

The general-purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

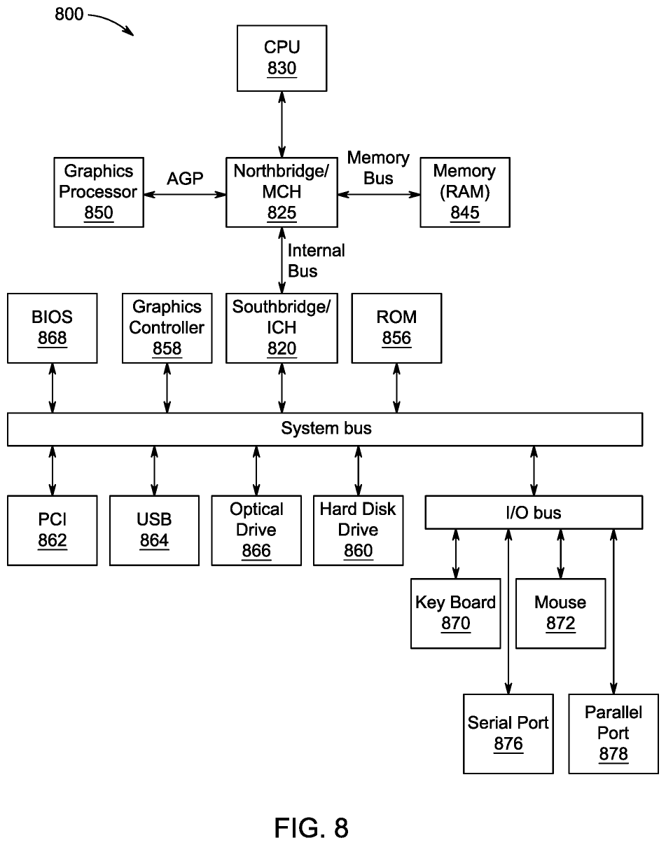

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to certain embodiments, for performing the functions of the exemplary embodiments. The data processing system is an example of a computer in which code or instructions implementing the processes of the illustrative embodiments may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

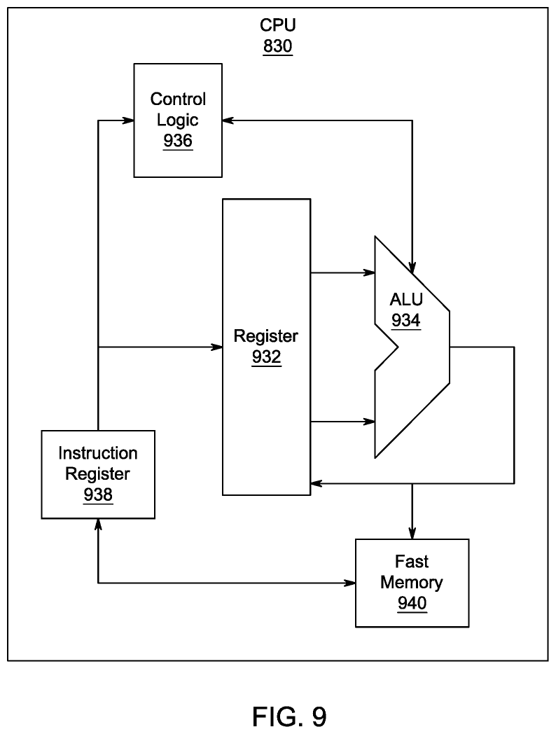

For example, FIG. 9 shows one implementation of CPU 830, according to an embodiment. In one implementation, the instruction register 938 retrieves instructions from the fast memory 940. At least parts of these instructions are fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 888 through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

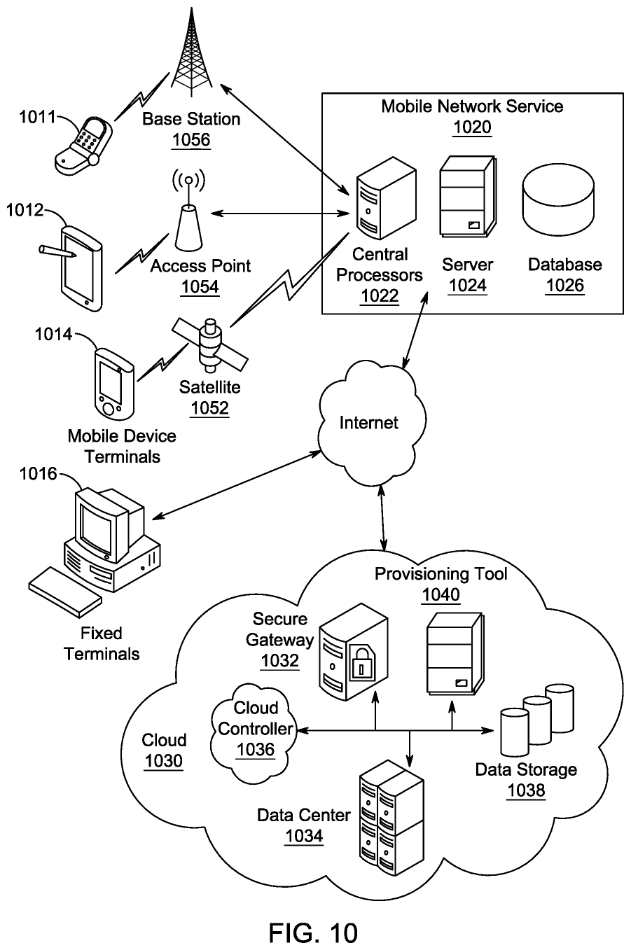

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 10, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A computer-implemented method of predicting a Seawater intrusion (SWI) index in coastal aquifers based on a plurality of parameters for a sustainable groundwater management, comprising:
determining values for each parameter of the plurality of parameters with a sensor network;
estimating a level of informative contribution of the plurality of parameters and a multicollinearity among the plurality of parameters;
selecting one or more parameters of the plurality of parameters based on the level of informative contribution and the multicollinearity to obtain an input dataset;
partitioning the input dataset into a modeling dataset and a testing dataset;
dividing the modeling dataset into a training set and a validation set;
tuning a plurality of hyperparameters based on a grid search strategy for a plurality of models;
training each model of the plurality of models based on the training set and the plurality of hyperparameters;
evaluating each model of the plurality of models based on the validation set to obtain a model evaluation, the testing dataset, and a plurality of statistical performance metrics;
selecting a prediction model from the plurality of models based on the testing dataset, the model evaluation, and the plurality of statistical performance;
predicting the SWI index from the prediction model; and
creating an adaptive groundwater management strategy based on the SWI index.

2. The method of claim 1, wherein the plurality of parameters comprises a bicarbonate concentration, a total dissolved solids concentration, a nitrate concentration, a nitrite concentration, an ammonium concentration, a chloride concentration, a sulphate concentration, a pH, an electrical conductivity, a calcium concentration, a magnesium concentration, a sodium concentration, a potassium concentration, or a combination thereof.

3. The method of claim 1, wherein predicting the SWI index does not include a chloride concentration in the plurality of parameters.

4. The method of claim 1, wherein the plurality of models is a Gradient Boosting Regressor, a Multilayer Perceptron, a Ridge Regression, a Decision Tree, a Random Forest, a SVM regression, a Bagging Regressor, a committee regressor, a stacking regressor, or a combination thereof.

5. The method of claim 1, wherein the plurality of statistical performance metrics is a correlation coefficient, a mean absolute error, a mean square error, a Bayesian information criterion, an Akaike information criterion, or a combination thereof.

6. The method of claim 1, wherein the selecting the prediction model further comprises:
ranking the plurality of models based on the model evaluation to obtain a rank;
creating a committee of models and a stack of models based on the rank; and
selecting the prediction model from the group consisting of the plurality of models, the committee of models, and the stack of models based on the rank;
wherein the committee of models comprises a set of preferred models of the plurality of models based on the rank, and the stack of models comprises a set of second-preferred models of the plurality of models based on the rank.

7. The method of claim 6, wherein the prediction model is the committee of models, and the predicting step further comprises calculating an arithmetic average of a plurality of SWI indexes obtained from the committee of models.

8. The method of claim 7, wherein the set of preferred models comprises three (3) models of the plurality of models.

9. The method of claim 6, wherein the prediction model is the stack of models, and the predicting step further comprises:
creating a stacking validation set based on the plurality of SWI indexes obtained from the stack of models and the validation set;
selecting a final prediction model from the stack of models based on the rank;
training the final prediction model based on the stacking validation set; and
predicting the SWI index with a trained final prediction model.

10. The method of claim 9, wherein the set of second-preferred models comprises four (4) models of the plurality of models.

11. The method of claim 2, wherein the plurality of parameters consists of bicarbonate, a total dissolved solids, nitrate, nitrite, ammonium, chloride, sulphate, a pH, an electrical conductivity, calcium, magnesium, sodium, potassium, and the prediction model is the Ridge Regression.

12. The method of claim 3, wherein the plurality of parameters consists of bicarbonate, a total dissolved solids, nitrate, nitrite, ammonium, sulphate, a pH, an electrical conductivity, calcium, magnesium, sodium, potassium, and the prediction model is the Multilayer Perceptron.

13. The method of claim 1, wherein the plurality of parameters further comprises a climate change parameter and a groundwater extraction scenario.

14. The method of claim 1, wherein the sensor network comprises an ion chromatography, a pH meter, a TDS meter, a titrator, and a water test kit.

15. The method of claim 1, wherein the adaptive ground management strategy comprises ponding surface water and stormwater runoff; recharging the groundwater table; promoting water conservation; and restricting groundwater withdrawals.

16. A sustainable groundwater resource management system, comprising:
a processor configured to execute a program instruction;
a storage device connected to the processor; and
a sensor network configured to measure a plurality of parameters and send the plurality of parameters to the storage device in one or more coastal aquifers in arid regions;
wherein the program instruction is configured to perform a method comprises:
determining values for each parameter of the plurality of parameters with a sensor network;
estimating a level of informative contribution of the plurality of parameters and a multicollinearity among the plurality of parameters;
selecting one or more parameters of the plurality of parameters based on the level of informative contribution and the multicollinearity to obtain an input dataset;
partitioning the input dataset into a modeling dataset and a testing dataset;
dividing the modeling dataset into a training set and a validation set;
tuning a plurality of hyperparameters based on a grid search strategy for a plurality of models;
training each model of the plurality of models based on the training set and the plurality of hyperparameters;
evaluating each model of the plurality of models based on the validation set to obtain a model evaluation and a plurality of statistical performance metrics;
selecting a prediction model from the plurality of models based on the testing dataset, the model evaluation, and the plurality of statistical performance;
predicting a Seawater intrusion (SWI) index from the prediction model; and
creating an adaptive groundwater management strategy based on the SWI index.

17. The system of claim 16, wherein the plurality of parameters excludes a chloride data.

18. The system of claim 17, wherein the plurality of parameters consists of bicarbonate, a total dissolved solids, nitrate, nitrite, ammonium, sulphate, a pH, an electrical conductivity, calcium, magnesium, sodium, potassium, and the prediction model is the Multilayer Perceptron.

19. The system of claim 16, wherein the sensor network comprises an ion chromatography, a pH meter, a TDS meter, a titrator, and a water test kit.

20. The system of claim 16, wherein the adaptive ground management strategy comprises ponding surface water and stormwater runoff; recharging the groundwater table; promoting water conservation; and restricting groundwater withdrawals.
